(19) United States
(12) Patent Application Publication
(10) Pub. No.: US 2012/0245712 A1
(43) Pub. Date: Sep. 27, 2012

(54) MOTION CONTROL SYSTEM

(75) Inventors: Rainer Möhring, Rothlein (DE); Jochen Schlinkert, Aeschi (CH); Jörg Vollmann, Adelsdorf (DE); Peter Wagner, Hersbruck (DE)

(73) Assignee: Siemens Aktiengesellschaft, Munchen (DE)

(21) Appl. No.: 13/240,184

(22) Filed: Sep. 22, 2011

(30) Foreign Application Priority Data
Sep. 22, 2010 (EP) EP10178336

(51) Int. Cl. G05B 19/19

(52) U.S. Cl. 700/56

(57) ABSTRACT

A motion control system has a first motion controller, a second motion controller, a data bus connecting the first motion controller and the second motion controller for data transmission and a global time, wherein both first trace data of the first motion controller and second trace data of the second motion controller have a time stamp dependent on the global time.

### CROSS-REFERENCES TO RELATED APPLICATIONS

This application claims the priority of European Patent Application, Serial No. EP10178336, filed Sep. 22, 2010, pursuant to 35 U.S.C. 119(a)-(d), the content of which is incorporated herein by reference in its entirety as if fully set forth herein.

### BACKGROUND OF THE INVENTION

The present invention relates to a motion control system.

A motion control system has for example a multiplicity of drives. To monitor functions and/or the behavior of the motion control system, data can be stored in a trace.

It would therefore be desirable and advantageous to obviate other prior art shortcomings by improving the analyzability of stored data.

### SUMMARY OF THE INVENTION

According to one aspect of the present invention, a.

The motion control system has for example a first drive and a second drive. For regulation and/or control of the drives a motion controller is provided for these drives. The motion controllers of the drives are linked via a data communication means, wherein for example a central unit for regulation and/or control can also be present. The motion control system relates for example to a production machine or a machine tool. Examples of machines of this kind are: grinding machines, milling machines, lathes, printing presses, presses, cranes, packaging machines, etc.

By means of time synchronization of different traces of different components of the motion control system the analyzability of the data from the traces can be improved. Examples of different components which can have a trace are: programmable controller, master computer, motion controller, cam controller, register control, etc. These components are different parts of an automation system, which for example serves to automate a machine tool or a production machine.

In one version a motion control system has a first motion controller, a second motion controller and a data bus. The data bus is for example a bus system based on Profibus, Ethernet or CAN-Bus. The motion control system further has a global time. The global time is for example a system time to which times of different components in the system can be related. The global time can also be the only time in the system. The global time can further be divided into different clock times.

First trace data is collected by means of the first motion controller. Secondary trace data is collected by means of the second motion controller. Examples of trace data are: actual current, actual voltage, control word, alarm signal, actual rotational speed value, actual position value, firing pulse, temperature, pressure, etc. The trace data of the motion controllers has a time stamp. The time of the time stamp of the first motion controller can be the same as or different to the time of the time stamp of the second motion controller. If the times are different it is at least known how the times relate to each other, so that the trace data from different motion controllers can be set relative to each other. For example the times can be set in relation to a global time. In one version of the system, the global time is, for example, the time of the first as well as the second motion controller. The global time can be transferred from a master timer via a data bus to the motion controllers. The trace data advantageously has a time stamp dependent on the global time. This relates to first trace data from the first motion controller and second trace data from the second motion controller. The trace data of the motion controllers can be stored in a trace memory in the respective motion controller, and read therefrom, in order to be combined with other trace data from further motion controllers. The trace data from the motion controllers can for example also be transferred direct from the motion controller to an external trace.

If different trace data items have a common time basis, these are easier to connect with each other. By means of the time synchronization of separate measurements (trace data) the separate measurements can for example be more simply overlaid in graphical form, in order to represent these in one window. Before being displayed, the trace data from the different measurements (from a first motion controller, from a further motion controller, . . . or from a first sensor, from a further sensor, . . . ) can also be mathematically processed (for example addition, subtraction, correlation functions, FFT, etc.). The representation of the trace data and/or its processing takes place for example in an engineering system or also in a control computer system. The engineering system further serves, for example, to perform the following tasks: programming of motional sequences, programming of a bus system, project engineering of an automation system, etc.

A motion controller can be embodied such that it has at least one microprocessor (in particular a CPU). Measurements of the trace data take place in particular with the assistance of at least one microprocessor. The measurement data is provided along with a time stamp, whereby it is possible, for example by means of an engineering system, to represent items of trace data as signals in chronologically correct relationship to each other.

Through the use of time stamps, which are issued for measurement purposes, the influence of communication topologies on the possibilities for analyzing the measured data can be reduced. The communication topology thus need not exercise any influence on the time-synchronous, distributed trace, insofar as the communication system has control over the topology. Time stamps are for example issued direct by the motion controller or by the sensor, wherein the motion controller and/or the sensor receives a time signal from a data bus. Receiving this enables in particular synchronization with the global time.

In one embodiment of the motion control system, the first motion controller has a first trace and the second motion controller has a second trace, wherein first trace data from the first trace is linked with second trace data from the second trace. Linkage already takes place by means of a time stamp, whose time is coupled with a global time. A further linkage arises for example through mathematical processing of both trace data items. It is thereby possible, for example to record signal data simultaneously on different control and/or regulation devices and to represent the resultant data in a time-synchronous manner in a graphic.

In one embodiment of the motion control system at least two motion controllers are coupled with each other via a synchronizing function. A first motion controller is accordingly linked to a second or to each further motion controller via a function (here for example a synchronizing function). The motion controllers have for example a master or also a control system. The functions of motion controllers can be synchronized via a bus system.

In a synchronized bus system with transfer of the system time (global time), then if the delay times are known, individual bus circuits and thus also the control systems are well defined relative to each other in terms of time, or can be precisely determined.

Through the use of the global time it is possible to realize a distributed trace with exact time-based representation of the signals relative to each other. The signals can be precisely assigned in terms of time, and thus also represented in a common trace with a high resolution time basis. Parametrization of the trace takes place for example by means of an engineering system. The start of one or more traces can be initiated via a trigger signal on the bus. A cross-project start can also be carried out, for example in connection with a cross-project synchronism.

In one embodiment of the motion control system data from different motion controllers is represented in a graphic trace in a time-synchronous manner. This is possible by means of a synchronized data bus. The system time, which serves synchronization purposes, is to be transferred via the bus.

A trigger can initiate the start of one or more traces. The trigger can be an internal software signal or also an external HW-trigger signal. Different separate traces can be initiated with just one trigger. The trigger signal can for example also be represented in a graphic together with the trace signals.

Through the use of time stamps which depend on a global time, a simultaneous, jointly triggered recording of signals on different automation systems and a time-synchronous representation and/or common representation in a graphical trace are possible.

Triggers can also be transferred via a second communication path, in which case the timing precision of the trigger events is not critical, if as described the trace values themselves have a time stamp.

In one embodiment of the system, recording of the data in a ring buffer takes place after initiation of the trace. The trace can be started in each motion controller of the overall system or also only in selected motion controllers. The trace can also be located in a stored-program controller (SPC), or in a control system or engineering system, wherein trace data from different devices (for example a sensor, actuator, controller, regulator) is transferred to the trace with a time stamp via the data bus. The time stamp is thus issued as close as possible to the source of the data and provided with a time stamp, which depends on a global time of a larger system with a multiplicity of communication participants.

If the engineering system stores trace data, an analysis can thus take place there. The recorded data is transferred to the engineering system with a time stamp. There the data items with the time stamps can be analyzed as regards their relation to each other, and transferred into a common time basis.

In one embodiment the trigger signal can be transmitted from a motion controller or from a CPU, at which the trigger occurs, to further, in particular all other devices within the system via UDP Broadcast. If a trigger signal occurs, or has been communicated, the trace values from the trigger onwards are written out of the ring buffer into the trace memory, or the values are no longer overwritten from the trigger signal onwards.

In one embodiment a trigger (trigger signal) is transmitted via a data bus to (in particular all) devices connected to the data bus. Time information (in particular a time stamp) can here be transmitted at the same time as the trigger signal. By means of this time information in conjunction with the global time it is possible to determine when the trigger actually occurred. To this end, for example, a runtime of the trigger information over the data bus is used. An automation device or a device on the data bus can for example derive information herefrom as to when data capture can be concluded in a time-synchronous manner (this represents a trace end). The time synchronicity here relates in particular to the clock time of the data bus.

Through the use of time stamps it is not essential for the trigger to be time-synchronous, as the values can initially be stored independently of this. A synchronization of trace data takes place via the global time-dependent time stamp. Here the advantageous properties of a synchronized communication system with precise time information across the entire system are clear. A separation of the communication of the trigger event from the recording and analysis process is here possible. The time-related resolution/precision can thus correspond to the exactness of the time synchronization in an isochronous communication system such as for example PROFINET IRT (IRT: Isochronous Realtime Ethernet).

The described variations of a motion control system in each case also relate to a corresponding method for operation of a motion control system. In one method for motion control a first motion controller is connected to a second motion controller via a data bus. First trace data of the first motion controller has a time stamp dependent on a global time. Second trace data of the second motion controller likewise has a time stamp which depends on the global time, wherein the different trace data is correlated via the time stamp.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a task assignment or a communication structure with a time-synchronous trace for a motion control system according to the present invention;

### DETAILED DESCRIPTION OF PREFERRED EMBODIMENTS

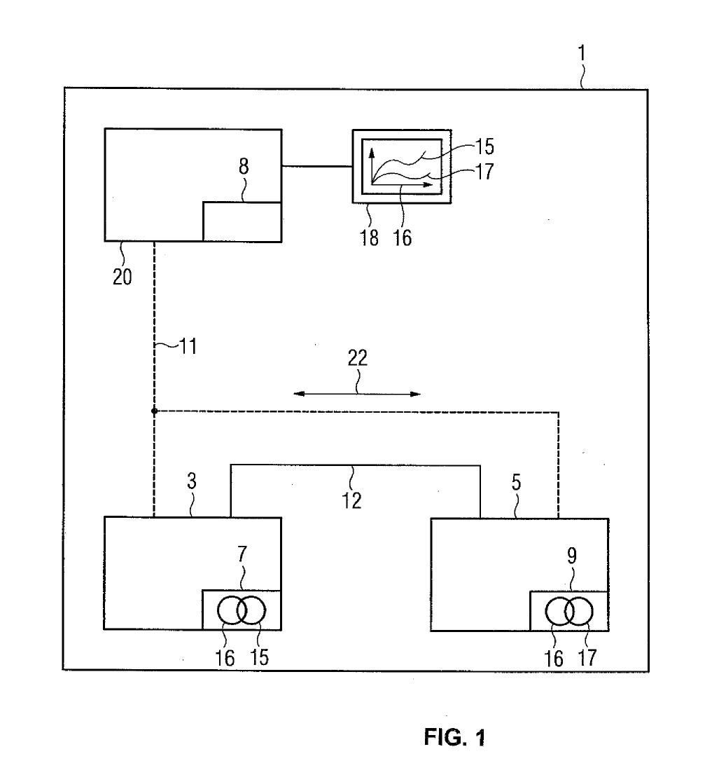

Turning now to the drawing, and in particular to FIG. 1, there is shown a first motion controller 3 and a second motion controller 5. The motion controllers 3, 5 can also take the form of drive systems, which also have a power converter for supplying current to an electrical machine. The first motion controller 3 has a first trace 7. The second motion controller has a second trace 9. The traces 7 and 9 can record signals, values and data which are available in the motion controllers 3 and 5. The first trace 7 has trace data 15, which is provided with a time stamp 16. This is represented in the figure by intersecting circles. The second trace 9 also has trace data 17 with time stamps 16. The motion controllers 3, 5 are connected to each other for data transmission via a data bus 11. The motion controllers 3 and 5 can likewise be connected to each other via a further data line 12 (for example Profinet IRT), The motion controllers 3 and 5 are connected to an engineering system 20 for data transmission via the data bus 11. The engineering system 20 has a trace 8. The trace data items 15 and 17, which has a time stamp, can for example be stored in this trace 8, after which these were transferred to the engineering system 20 via the data bus 11. If only the engineering system 20 has a trace 8 and if no traces are present in the motion controllers (not shown in the figure), then data to be traced can be transmitted directly from the motion controllers to the engineering system 20 in order to be able to store it there in the trace 8. Here, the data is already transferred to the engineering system 20 with the time stamp, which is oriented towards a global time, via the data bus 11. The global time 22 too is communicated via the bus 11.

The transmission of recording data (trace data) can take place via a separate Ethernet connection, which represents a data bus, or also via a Profinet string 12.

Transmission of a trigger can for example take place via a asynchronous communication path (for example UDP (User Data Protocol) on Profinet string).

The engineering system 20 has a monitor 18 for displaying the trace data 15 and 17, wherein this is represented in a joint graphic by a time axis for the time stamp data 16. This serves to provide a time-synchronous representation of data from different devices, here motion controllers.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A motion control system comprising:
a first motion controller having first trace data, with the first trace data having a time stamp dependent on a global time,
a second motion controller having second trace data, with the second trace data having a time stamp dependent on the global time, and
a data bus connecting the first motion controller and the second motion controller for data transmission.

2. The motion control system of claim 1, wherein the first motion controller has a first trace with the first trace data and the second motion controller has a second trace with the second trace data, wherein the first trace data of the first trace are linked with the second trace data of the second trace.

3. The motion control system of claim 1, wherein the first motion controller and the second motion controller are linked with each other via a synchronizing function.

4. The motion control system of claim 1, wherein the trace data from the first and second motion controllers are represented in a time-synchronous manner in a graphic.

5. The motion control system of claim 1, wherein the data bus is synchronized, wherein the data bus has a system time used for synchronization.

6. The motion control system of claim 1, wherein at least one of the first and second trace is started by a trigger.

7. The motion control system of claim 1, further comprising a ring buffer for storing at least one of the first and second trace data.

8. The motion control system of claim 1, wherein at least one of the first and second trace data is stored in an engineering system.

9. The motion control system of claim 1, wherein the data bus transmits a trigger to a device, wherein the trigger has time information.

10. The motion control system of claim 9, wherein the time information includes information about a trace end.

11. The motion control system of claim 10, wherein the trace end is time-synchronized.

12. A method for motion control, comprising the steps of
connecting a first motion controller to a second motion controller via a data bus,
applying a time stamp dependent on a global time to first trace data of the first motion controller,
applying a time stamp dependent on the global time to second trace data of the second motion controller, and
linking the first and second trace data via the time stamp.

13. The motion control system of claim 1, wherein the first and second trace data comprise data selected from the group consisting of actual current, actual voltage, control word, alarm signal, actual rotational speed value, actual position value, firing pulse, temperature, and pressure.

14. The method of claim 12, wherein the first and second trace data comprise data selected from the group consisting of actual current, actual voltage, control word, alarm signal, actual rotational speed value, actual position value, firing pulse, temperature, and pressure.
